(19) United States
(12) Patent Application Publication
(10) Pub. No.: US 2006/0028829 A1
(43) Pub. Date: Feb. 9, 2006

(54) Vehicular marker lamp

(75) Inventors: Yasuyuki Amano, Shizuoka (JP); Kazunori Natsume, Shizuoka (JP)

Correspondence Address: KODA & ANDROLIA, 2029 CENTURY PARK EAST, SUITE 1140, LOS ANGELES, CA, 90067, US

(73) Assignee: Koito Manufacturing Co., Ltd.

(21) Appl. No.: 11/201,250

(22) Filed: Aug. 9, 2005

(30) Foreign Application Priority Data
Aug. 9, 2004 (JP) 2004-231875

(51) Int. Cl. B60Q 1/26; F21V 33/00; G02B 27/30; G02B 3/00; G09F 9/33

(52) U.S. Cl. 362/505; 362/506; 340/815.45; 340/468; 359/641; 359/642

(57) ABSTRACT

A vehicular marker lamp including a LED with its optical axis L disposed in the forward direction of the lamp, a lens provided in front of the LED, and a reflector provided in the vicinity of the LED. Formed on the lens are a curved reflective surface and a transparent portion, so that the curved reflective surface reflects light from the LED toward the reflector side and forms a virtual light source image of such reflected light at a position separate from the optical axis L, and the transparent portion allows re-reflected light, which has been reflected by the curved reflective surface and then re-reflected by a reflective surface of the reflector 26, to pass therethrough to the front of the lamp. The reflective surface is formed in a curved shape and is proived so that its focal point is on the virtual light source image.

### BACKGROUND OF THE INVENTION

1. Field of the Invention

The present invention relates to a vehicular marker lamp and more particularly to a vehicular marker lamp which is used as a tail lamp, a stop lamp or the like and which employs LEDs as the light source.

2. Description of the Related Art

A vehicular marker lamp that uses an LED (light-emitting diode) as a light source is already known. So as to increase the light-emitting area, in this type of vehicular marker lamp, the reflector is disposed in the vicinity of (or around) the LED, so that light radiating from the LED is directly radiated to the front lens, and light from the LED is also reflected by the reflector and this reflected light is radiated to the front lens. However, such a structure in which the light from the LED is radiated toward the front lens and also reflected by the reflectors so that the reflected light is radiated to the front lens too is inadequate for uniformly irradiating the entire front lens.

As a result, a so-called double-reflecting type of lamp as shown in FIG. 12 has been proposed (see, for instance, Japanese Patent Application Laid-Open (Kokai) No. 2001-283616, particularly pages 2 to 3 and FIG. 1). In this double-reflecting type lamp, a elliptically-shaped reflective surface 3 is formed in the front lens 5 so that the reflective surface 3 is located in the region that corresponds to the optical axis X of the LED 2, thus allowing light radiated from the LED 2 to be reflected by the reflective surface 3 and then reflected by the main reflective surface 4, thus being radiated to the front lens 5 side.

In this vehicular marker lamp shown in FIG. 12, the reflective surface 3 forms a virtual light source image at a position further forward than the position of the actual light source (a position separate from the main reflective surface 4), that is, at a position 3b of the second focal point. Accordingly, by way of increasing the area of the main reflective surface 4 to which the light radiates, it is possible to increase the light-emitting area and to uniformly irradiate the front lens 5.

However, in the above described related art, the position of the virtual light source image is on the optical axis of the LED; accordingly, a portion of the reflected light from the reflective surface 3 becomes incident to a non-light-emitting area around the LED 2 and is thus wasted. However, in the related art, a diffusing reflective surface 4a is formed on the main reflective surface 4; as a result, the reflected light, which is among the reflected light reflected by the rotational reflective ellipsoid 3 and in the vicinity of the optical axis, does not become incident to the reflective surface 3. Even so, it is difficult for the main reflective surface 4 to reflect and radiate all the reflected light, which is reflected by the rotational reflective ellipsoid 3, to the front lens 5 side, because the virtual light source image is on the optical axis of the LED 2. Accordingly, reflected light is not effectively utilized in a satisfactory manner.

### BRIEF SUMMARY OF THE INVENTION

The present invention was devised in light of the foregoing problems in the related art described above, and it is an object of the present invention to provide a vehicular marker lamp that effectively utilizes reflected light even when it uses a double-reflecting type optical system.

The above object is accomplished by a unique structure of the present invention for a vehicular marker lamp that includes an LED that has an optical axis disposed in the forward direction of the lamp, a lens that is disposed in front of the LED and on the optical axis of the LED, and a reflector with its reflective surface disposed to face the lens and in the vicinity of the LED; and in the present invention, the lens has a curved reflective portion that reflects light from the LED to the reflector side and forms a virtual light source image of such reflected light at a position separate from the optical axis of the LED, and the lens further has a transparent portion that allows re-reflected light, which is reflected light that has been reflected by the curved reflective portion and then re-reflected by the reflector, to pass therethrough toward the front of the lamp; and the reflective surface of the reflector is formed to be a curved surface in which the focal point of the curved reflective surface is on the virtual light source image.

In the above structure of the present invention, when light radiated from the LED is guided to the front of the lamp, light, which is among the light radiated from the LED and is in the vicinity of and on the optical axis of the LED, is reflected by the curved reflective portion of the lens. This reflected light is further reflected by the reflector, after which it passes through the transparent portion of the lens and is guided to the front of the lamp as re-reflected light. When light from the LED is reflected by the curved reflective portion of the lens, the virtual light source image from such reflected light is formed at a position separate from the optical axis of the LED (or such an image is not formed on the optical axis of the LED). Moreover, the reflective surface of the reflector is formed to be a curved surface, and the reflector is provided so that the focal point of its curved reflective surface is positioned on such a virtual light source. Accordingly, reflected light from the curved reflective portion and reflected light (re-reflected light) from the reflector are effectively guided, i.e., guided without being wasted, to the front of the lamp via the transparent portion. It is thus possible to achieve an improvement in the light flux utilization rate while securing an adequate light-emitting area. Furthermore, the distance between the lens and the LED can be made shorter than in a single-reflecting type of lamp; accordingly, a shorter depth dimension is assured, and it is possible to provide a slimmer or thinner lamp.

In the vehicular marker lamp of the present invention, the lamp is structured so that the focal point of the curved reflective portion of the lens is positioned on the LED.

With this structure in which the curved reflective portion is provided so that its focal point is positioned on the LED, light, which is among the light radiated from the LED and is in the vicinity of the optical axis, can be reflected toward the reflector, and then the reflected light is effectively radiated, i.e., radiated without being wasted, to the reflector.

As is evident from the above, according to the vehicular marker lamp of the present invention, the lamp has improved light flux utilization rate and has an adequate light-emitting area.

Furthermore, according to the present invention, the reflected light from the lens can be effectively radiated to the reflector.

### BRIEF DESCRIPTION OF THE DRAWINGS

FIG. 1 is a front elevational view of the vehicular marker lamp according to one embodiment of the present invention;

FIG. 2A is a structural drawing of the radial lens steps formed on the front surface side of a lens used in the vehicular marker lamp shown in FIG. 1, and FIG. 2B is a structural drawing of the radial lens steps formed on the back surface side of the lens;

FIG. 3 is a perspective view of the vehicular marker lamp of FIG. 1;

FIG. 4 is a cross-sectional view taken along the line 4-4 in FIG. 1;

FIG. 5 is a cross-sectional view taken along the line 5-5 in FIG. 1;

FIG. 6 is a front elevational view of the vehicular marker lamp according to another embodiment of the present invention;

FIG. 7A is a structural drawing of the radial lens steps formed on the front surface side of a lens used in the vehicular marker lamp shown in FIG. 6, and FIG. 7B is a structural drawing of the radial lens steps formed on the back surface side of the lens;

FIG. 8 is a perspective view of the vehicular marker lamp of FIG. 6;

FIG. 9 is a cross-sectional view taken along the line 9-9 in FIG. 6;

FIG. 10 is a cross-sectional view taken along the line 10-10 in FIG. 6;

FIG. 11 is an explanatory drawing showing the relationship of a virtual light source image, a curved reflective portion and a reflector; and

FIG. 12 is a cross-sectional view of a vehicular lamp of related art.

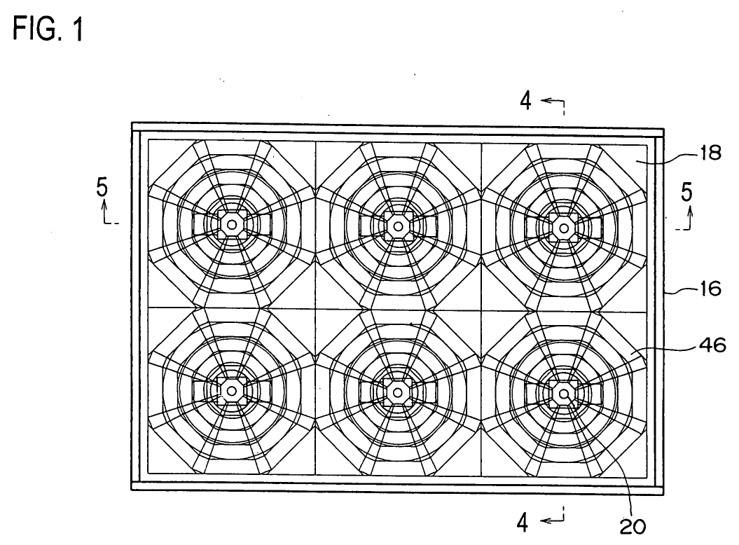

### DETAILED DESCRIPTION OF THE INVENTION

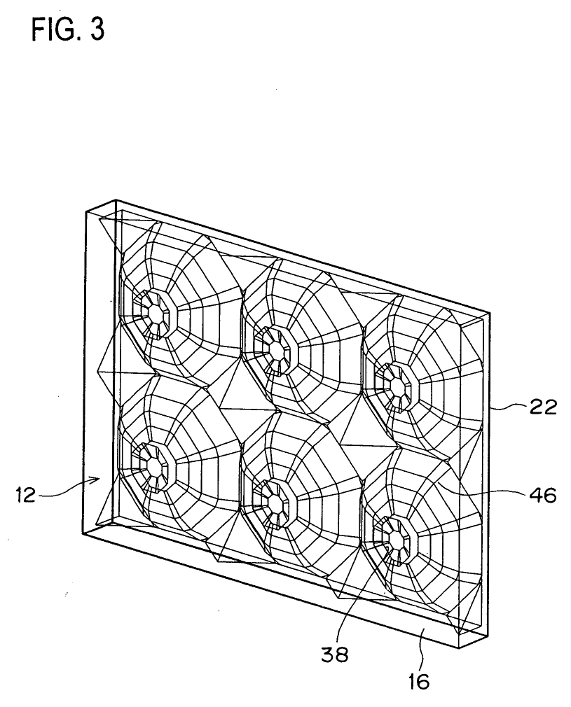

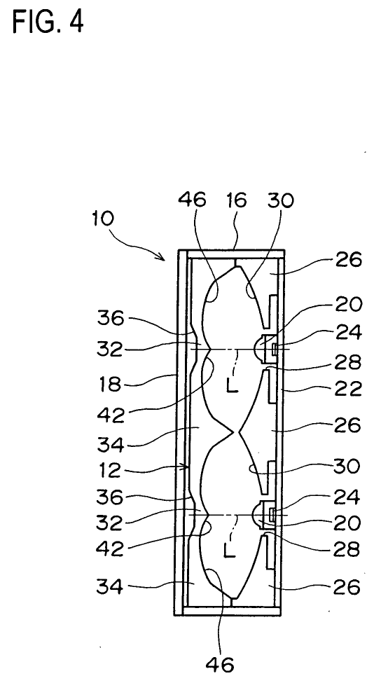

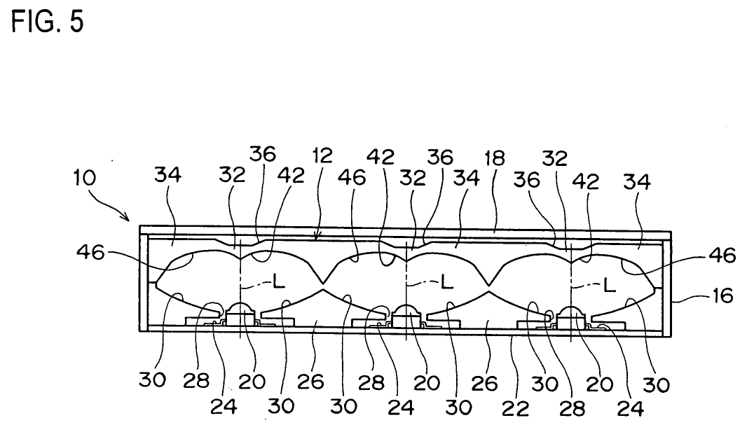

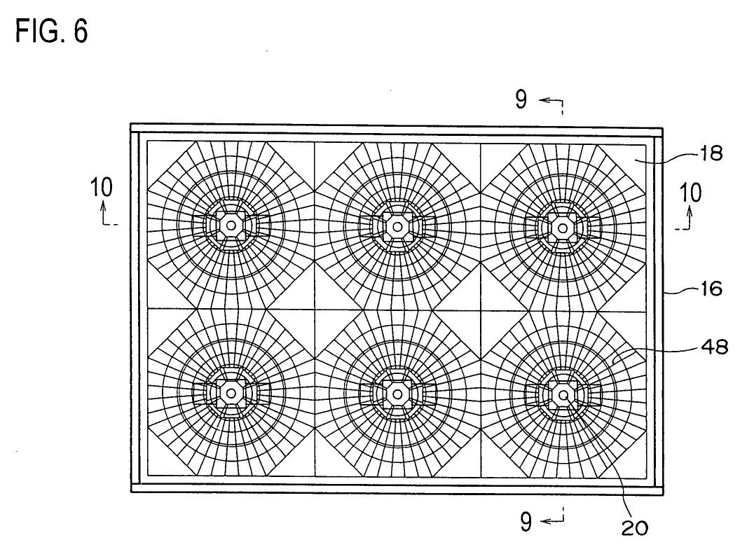

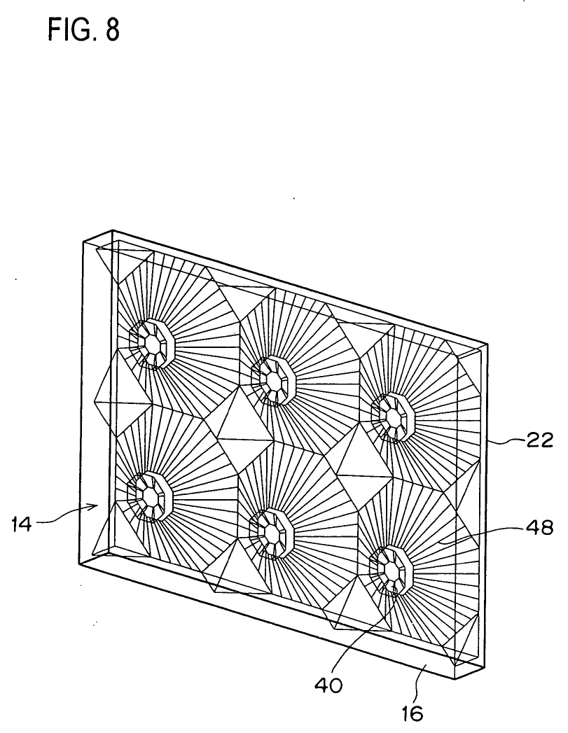

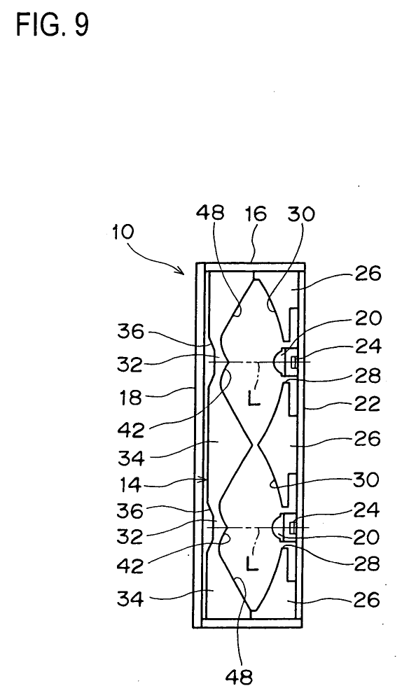

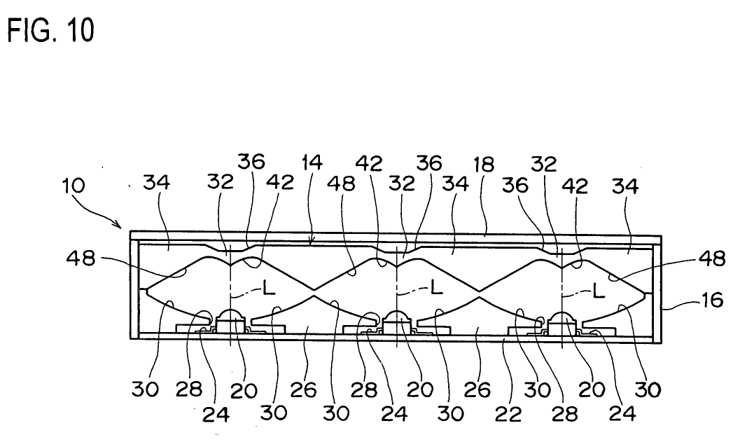

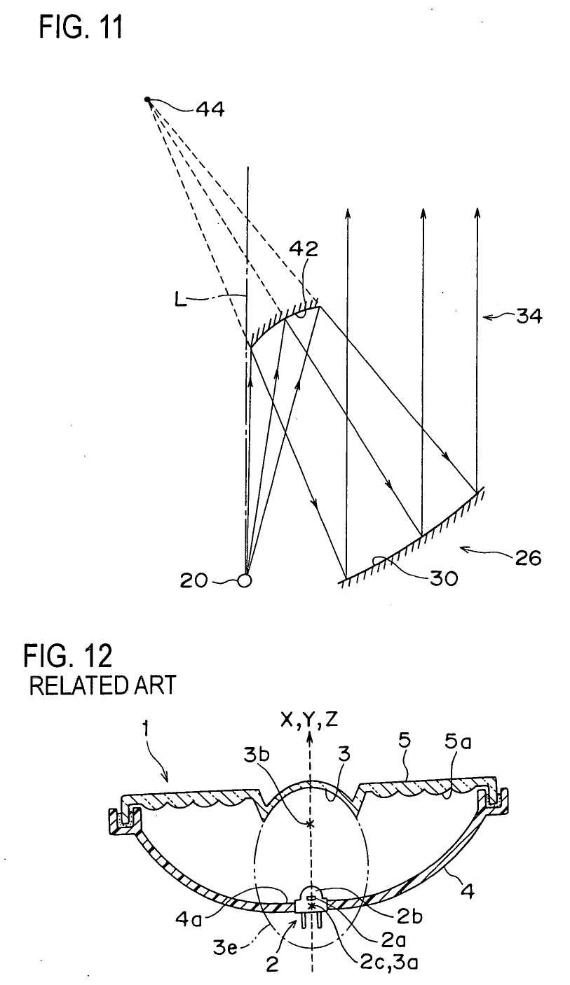

The vehicular marker lamp 10 of the present invention is, for example, a tail and stop lamp that is installed within a lamp mounted in the rear left corner or in the rear right corner of a vehicle. In one type of lamp (called “type A”), a lens (inner lens) 12 shown in FIG. 3 is provided; and in another type of lamp (called “type B”), a lens (inner lens) 14 shown in FIG. 8 is provided. Both types includes in common a lamp body 16, a front cover 18, an LED 20, an LED base 22 and a reflector 26, which are all, except for the LED 20, formed by mainly resins. For example, the lenses 12, 14 are structured using a resin such as acrylic and PC (polycarbonate), while the lamp body 16, the front cover 18, the LED base 22 and the reflector 26 are formed by a resin such as ABS (acrylonitrile-butadiene-styrene) and AAS (acrylonitrile-acrylic-styrene).

The lamp body 16 is a hollow cylindrical frame with a cross section thereof formed in an oblong shape. The front cover 18 is in an oblong shape and attached to the front surface side of the lamp body 16, and the LED base 22 has an oblong shape and attached to the back surface side of the lamp body 16. The entire inner surface of the lamp body 16 is aluminized. Six LEDs 20 are provided at specified intervals on the LED base 22, and a terminal 24 of each LED 20 is connected to the power source or the drive circuit (both not shown) via a bus bar (not shown) that is formed on the LED base 22. Each LED 20 is disposed on the LED base 22, which is formed on a flat plate, such that the optical axis L is substantially perpendicular to the LED base 22. Furthermore, each LED is provided so that the optical axis L is directed toward the front of the lamp, that is, the front of the front cover 18.

A reflector 26 is disposed in the vicinity of each LED 20, and each reflector 26 is an integrated die cast element. The back surface side of the reflector 26 is fixed to the LED base 22, and the side surface sides are fixed to the inner surface of the lamp body 16. In the central portion of each reflector 26, a through hole 28 is formed so that the optical axis L of each LED 20 is at the center thereof, and the LEDs 20 are positioned inside the through holes 28. The surface of the reflector that faces the lens 12 or the lens 14 is formed to be a curved shape with the rim of the through hole 28 serving as a crown portion. The entire surface thereof is aluminized to form a reflective surface 30.

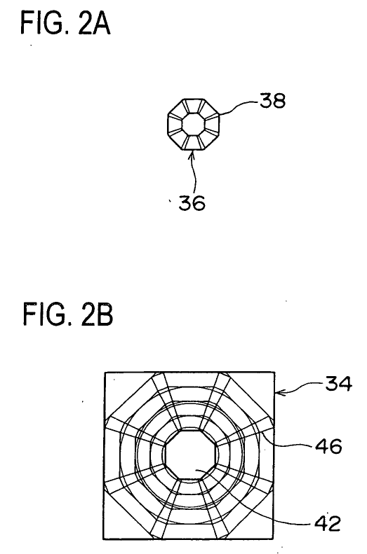

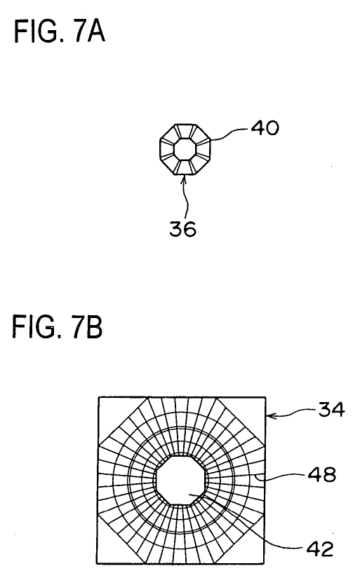

The lens 12, 14 disposed to face each reflector 26 is structured as a casting part, and its outer peripheral side is fixed to the inner surface of the lamp body 16. Each lens 12, 14 is formed with a curved reflective portion 32, which is generally formed as a disc on a central portion thereof, and a toric transparent portion 34, which is formed in the vicinity of (or around) the curved reflective portion 32. A toric stepped portion 36 is formed on the surface among the curved reflective portion 32 of the lenses 12, 14, which faces the front cover 18. As shown in FIG. 2A, radial lens steps 38 are formed on the stepped portions 36 of the lens 12, and radial lens steps 40 are formed on the stepped portions 36 of the lens 14, as shown in FIG. 7A.

In addition, a curved reflective surface 42 is formed on the surface that faces the reflector 26 among the curved reflective portion 32 of the lens 12, 14. The curved reflective surface 42 is formed in a curved shape, with a point that intersects the optical axis L of the LED 20 serving as a crown portion. As shown in FIG. 11, the curved reflective surface 42 takes an elliptical shape with its focal point being on the LED 20. Light radiated from the LED 20 is reflected toward the reflector 26 side, and a virtual light source image 44 of such reflected light is formed at a position separate from the optical axis L. Reflected light that is reflected by the curved reflective surface 42 is re-reflected by the reflective surface 30 of the reflector 26 and is once radiated toward the transparent portion 34 side as reflected light. In the shown embodiment, the reflective surface 30 of the reflector 26 is formed in a curved shape with a focal point thereof being on the virtual light source image 44. This structure ensures that the re-reflected light which is re-reflected by the reflective surface 30 of the reflector 26 is not wasted, i.e., is effectively guided to the transparent portion 34.

The transparent portion 34 is structured such that the re-reflected light which is re-reflected by the reflective surface 30 is transmitted toward the lamp front, that is, toward the front of the front cover 18. Moreover, the surface of the transparent portion 34 that faces the reflector 26 is formed in a curved shape. At the region formed in the curved shape in the lens 12 of the type A lamp shown in FIG. 3, radial lens steps 46 are formed in the configuration shown in FIG. 2B; and on the other hand, for the lens 14 which is of the type B shown in FIG. 8, radial lens steps 48 take the configuration shown in FIG. 7B. In other words, the lens 12 and the lens 14 differ only in the shape of the radial lens steps 38, 40, 46, 48 and are otherwise formed in the identical structures.

When the vehicular marker lamp 10 that has the structure described above is mounted on a vehicle and is brought into a tail and stop lamp mode, light from each LED 20 is radiated by the operation of the drive circuit (not shown). Light radiated from each LED 20 is incident to the curved reflective portion 32, and the incident light is reflected by the curved reflective surface 42; and such reflected light is then incident to the reflector 26, and the incident light is re-reflected by the reflective surface 30. The light is subsequently guided to the transparent portion 34 as re-reflected light, after which it is refracted by the transparent portion 34 and then radiated to the front of the lamp via the front cover 18.

More specifically, subsequent to being reflected by the curved reflective surface 42 of the curved reflective portion 32, light radiated from the LED 20 is re-reflected by the reflective surface 30 of the reflector 26. The light then passes through the transparent portion 34 and is guided toward the front of the lamp after the so-called “double-reflecting.” Since the curved reflective surface 42 is formed in a curved shape with the LED 20 as its focal point (or since the curved reflective surface 42 is provided so that its focal point is on the LED 20), it is possible to reflect light from the LED 20 to the reflector 26 side. Furthermore, the virtual light source image 44 of reflected light from the curved reflective surface 42 is formed at a position separate from the optical axis L, and the curved reflective surface 30 of the reflector 26 is formed in a curved shape with its virtual light source image 44 as the focal point (or the curved reflective surface 30 is provided so that its focal point is on the virtual light source image 44). Therefore, the reflected light that is re-reflected by the reflective surface 30 of the reflector 26 is not wasted, i.e., such light can be effectively guided to the transparent portion 34. Consequently, it is possible to improve the light flux utilization rate while securing an adequate light-emitting area.

In the shown embodiment, light radiated from the LED 20 is reflected twice. Accordingly, the distance between the LED 20 and the lens 12 or 14 can be shorter than in a single-reflecting type lamp, and it is possible to provide a slimmer lamp.

1. A vehicular marker lamp comprising an LED with an optical axis thereof disposed in a forward direction of the lamp, a lens provided in front of the LED and on the optical axis of the LED, and a reflector disposed in the vicinity of the LED with a reflective surface thereof facing the lens, wherein
said lens has:
a curved reflective portion that reflects light from the LED toward the reflector side and forms a virtual light source image of the reflected light at a position separate from the optical axis of the LED, and
a transparent portion that allows re-reflected light to pass therethrough to a front of the lamp, said re-reflected light being light that has been reflected by said curved reflective portion of the lens and then re-reflected by the reflector; and
said reflective surface of the reflector is a curved surface with a focal point thereof being on said the virtual light source image.

2. The vehicular marker lamp according to claim 1, wherein the curved reflective portion of the lens has a focal point thereof on the LED.
